(19) United States
(12) Patent Application Publication
(10) Pub. No.: US 2021/0253772 A1
(43) Pub. Date: Aug. 19, 2021

(54) POLYOXAZOLIDINONE COMPOSITIONS

(71) Applicant: Covestro LLC, Pittsburgh, PA (US)

(72) Inventors: Alan Ekin, Coraopolis, PA (US); David P. Zielinski, Cranberry Township, PA (US)

(21) Appl. No.: 16/792,939

(22) Filed: Feb. 18, 2020

(51) Int. Cl. C08G 18/00; C09D 175/00; C08G 18/73

(52) U.S. Cl. CPC C08G 18/003; C08G 18/73; C09D 175/00

(57) ABSTRACT

A polyoxazolidinone composition can include a reaction product of 1,5-pentamethylene diisocyanate-based polyisocyanate and poly-functional epoxide, wherein the 1,5-pentamethylene diisocyanate-based polyisocyanate and the poly-functional epoxide are combined at an equivalent ratio of from about 0.5:1 to about 1.5:1 isocyanate equivalents to epoxide equivalents in the presence of a reaction catalyst.

### BACKGROUND

Polyurethanes are a family of isocyanate-based materials that have a wide variety of uses. For example, polyurethanes can be employed in the manufacture of flexible and rigid foams, fibers, coatings, elastomers, etc. Further, polyurethane materials are becoming increasingly prevalent in the manufacture of automobiles, autobody repair, and building insulation materials. One potential drawback to polyurethanes is that some chemistries have limited high-temperature applications due to degradation of the urethane group. Therefore, there is a need for materials having improved high-temperature resiliency.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 milligrams to about 80 milligrams” should also be understood to provide support for the range of “50 milligrams to 80 milligrams.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### EXAMPLE EMBODIMENTS

An initial overview of invention embodiments is provided below and specific embodiments are then described in further detail. This initial summary is intended to aid readers in understanding the technological concepts more quickly, but is not intended to identify key or essential features thereof, nor is it intended to limit the scope of the claimed subject matter.

As described above, some polyurethanes can be limited when it comes to high-temperature applications due to degradation of the urethane group. The present disclosure describes an alternative material or composition that can be employed with good high-temperature resiliency. More specifically, the present disclosure is directed to polyoxazolidinone compositions prepared from the reaction of a poly-functional epoxide with a polyisocyanate based on 1,5-pentamethylene diisocyanate (PDI) at an approximately stoichiometric ratio.

As PDI homopolymers or adducts are generally safer to work with than PDI monomer, the present disclosure is primarily directed to PDI homopolymers, PDI adducts, or the like, although PDI monomer could also be used. For the sake of brevity, the PDI homopolymers, PDI adducts, or the like will generally be referred to herein as “PDI-based polyisocyanates.” It is noted that “PDI-based polyisocyanates” generally does not include PDI-based prepolymers where PDI is combined and allowed to react with a polyol, polyamine, or the like prior to combining with the multi-functional epoxide. In some examples, the PDI-based polyisocyanates can be substantially free of PDI monomer. In some specific examples, the PDI-based polyisocyanates can include less than or equal to 0.5 wt %, or less than or equal to 0.3 wt % residual PDI monomer based on a total weight of the PDI-based polyisocyanate. A variety of PDI-based polyisocyanates can be combined with poly-functional epoxide to provide a polyoxazolidinone composition with good high-temperature stability. For the sake of clarity, the polyoxazolidinone compositions described herein are prepared exclusively, or nearly exclusively, from PDI-based polyisocyanates. Thus, in some examples, less than 10%, less than 5%, less than 3%, less than 1%, or less than 0.1% of isocyanate equivalents of the polyisocyanate employed to prepare the polyoxazolidinone compositions described herein are derived from a polyisocyanate other than PDI. In other words, in some examples, the PDI-based polyisocyanates can include at least 90%, at least 95%, at least 97%, at least 99%, or at least 99.9% of the isocyanate equivalents employed to prepared the polyoxazolidinone compositions.

As used herein, the term “polyisocyanate” refers to compounds comprising at least two un-reacted isocyanate groups. The term “diisocyanate” refers to compounds having two un-reacted isocyanate groups. Thus, “diisocyanate” is a subset of “polyisocyanate.” Polyisocyanates can include isocyanate-functional biurets, isocyanate-functional isocyanurates, isocyanate-functional uretdiones, isocyanate-functional urethanes, isocyanate-functional ureas, isocyanate-functional iminooxadiazine diones, isocyanate-functional oxadiazine diones, isocyanate-functional carbodiimides, isocyanate-functional acyl ureas, isocyanate-functional allophanates, the like, or combinations thereof. In some specific examples, PDI-based polyisocyanates can include a biuret-containing polyisocyanate, an isocyanurate-containing polyisocyanate, a uretdione-containing polyisocyanate, an allophanate-containing polyisocyanate, the like, or a combination thereof.

As non-limiting examples, isocyanurates may be prepared by the cyclic trimerization of diisocyanates. Trimerization may be performed, for example, by reacting three (3) equivalents of a diisocyanate (e.g., PDI) to produce 1 equivalent of isocyanurate ring. Compounds, such as, for example, phosphines, Mannich bases and tertiary amines, such as, for example, 1,4-diaza-bicyclo[2.2.2]octane, dialkyl piperazines, and the like, may be used as trimerization catalysts. Iminooxadiazines may be prepared by the asymmetric cyclic trimerization of diisocyanates. Uretdiones may be prepared by the dimerization of a diisocyanate. Allophanates may be prepared by the reaction of a diisocyanate with a urethane. Biurets may be prepared via the addition of a small amount of water to two equivalents of diisocyanate and reacting at slightly elevated temperature in the presence of a biuret catalyst. Biurets may also be prepared by the reaction of a diisocyanate with a urea.

As described above, the PDI-based polyisocyanates can be prepared from PDI monomer. The PDI monomer can be bio-based PDI or synthetically produced PDI. By “bio-based,” it is meant that at least one PDI production step is performed with the aid of an enzyme. For example, as described in U.S. Pat. No. 8,044,066, which is incorporated herein by reference, lysine can be enzymatically decarboxylated to produce 1,5-pentanediamine, which can be subsequently converted to PDI via phosgenation or other suitable process to produce bio-based PDI. Thus, in some examples, the PDI-based polyisocyanate can be bio-based PDI. Additional methods for producing PDI monomer are described in U.S. Pat. No. 10,173,970, GB 1225450, and EP 2684867, each of which is incorporated herein by reference.

In some examples, the PDI-based polyisocyanates can have an isocyanate content of from about 18% NCO to about 28% NCO. In some additional examples, the PDI-based polyisocyanates can have an isocyanate content of from about 20% NCO to about 25% NCO, or from about 21% NCO to about 23% NCO. In still further examples, the PDI-based polyisocyanates can have an isocyanate content of from about 18% NCO to about 22% NCO, from about 20% NCO to about 24% NCO, or from about 22% NCO to about 26% NCO.

A variety of poly-functional epoxides can be combined with PDI-based polyisocyanate to produce the polyoxazolidinone compositions described herein. Non-limiting examples can include resorcinol diglycidyl ether, neopentyl glycol diglycidyl ether, 1,6-hexanediol diglycidyl ether, butanediol diglycidyl ether, bisphenol A diglycidyl ether, bisphenol F diglycidyl ether, bisphenol S diglycidyl ether, hydrogenated bisphenol A diglycidyl ether, glycerol polyglycidyl ether, trimethylol propane polyglycidyl ether, pentaerythritol polyglycidyl ether, diglycerol polyglycidyl ether, polyglycerol polyglycidyl ether, sorbitol polyglycidyl ether, diglycidyl terephthalate, diglycidyl o-phthalate, N-glycidyl phthalimide, ethylene glycol diglycidyl ether, polyethylene glycol diglycidyl ether, diethylene glycol diglycidyl ether, propylene glycoldiglycidyl ether, dipropylene glycol diglycidyl ether, poly propylene glycol diglycidyl ether, polybutadiene diglycidyl ether, epoxyphenol (novolac) resins, cycloaliphatic epoxides such as 3,4-epoxycyclohexylmethyl-3′,4′-epoxycyclohexane carboxylate, tetrabrominated bisphenol A (TBBPA, 2,2-bis(3,5-dibromophenyl)propane), diglycidyl ether, 2,2-bis[3,5-dibromo-4-(2,3-epoxypropoxy)phenyl]propane, dibromo neopentyl glycol diglycidyl ether, N,N,N′,N′-tetraglycidyl-bis-(4-aminophenyl)-methane, diglycidyl ether of diphenol derived from cashew nutshell liquid, diglycidyl ether of tetramethyl biphenyl, 1,1,1-tris-(p-hydroxyphenyl)ethanetriglycidylether, tetraphenol of ethane tetraglycidylether, trimethylolethane triglycidyl ether, dimer fatty acid diglycidyl ester, castor oil triglycidyl ether, the like, or a combination thereof.

In some examples, the poly-functional epoxide can have an epoxide equivalent weight of from about 80 grams per equivalent (g/eq) to about 500 g/eq based on ASTM D1652-11 (2019). In still additional examples, the poly-functional epoxide can have an epoxide equivalent weight of from about 100 g/eq to about 400 g/eq or from about 200 g/eq to about 300 g/eq based on ASTM D1652-11(2019). In some specific examples, the poly-functional epoxide can have an epoxide equivalent weight of from about 80 g/eq to about 200 g/eq, from about 100 g/eq to about 300 g/eq, from about 200 g/eq to about 400 g/eq, or from about 300 g/eq to about 500 g/eq.

In some additional examples, the poly-functional epoxide can have a viscosity of from about 50 mPa·s to about 20,000 mPa·s based on ASTM D445-19a. In some further examples, the poly-functional epoxide can have a viscosity of from about 50 mPa·s to about 5000 mPa·s, from about 5000 mPa·s to about 10,000 mPa·s, from about 10,000 mPa·s to about 15,000 mPa·s, or from about 15,000 mPa·s to about 20,000 mPa·s based on ASTM D445-19a. In some specific examples, the poly-functional epoxide can have a viscosity of from about 2000 mPa·s to about 7000 mPa·s, from about 8000 to about 12,000 mPa·s, or from about 13,000 to about 18,000 mPa·s based on ASTM D445-19a.

The PDI-based polyisocyanate and the multi-functional epoxide can generally be combined and allowed to react at an approximately stoichiometric ratio. In some examples, the PDI-based polyisocyanate and the multi-functional epoxide can be combined and allowed to react at an equivalent ratio of isocyanate equivalents to epoxide equivalents of from about 0.5:1 to about 1.5.1. In some additional examples, the PDI-based polyisocyanate and the multi-functional epoxide can be combined and allowed to react at an equivalent ratio of isocyanate equivalents to epoxide equivalents of from about 0.7:1 to about 1.3.1, from about 0.8:1 to about 1.2:1, or from about 0.9:1 to about 1.1:1. In some specific examples, the PDI-based polyisocyanate and the multi-functional epoxide can be combined and allowed to react at an equivalent ratio of isocyanate equivalents to epoxide equivalents of from about 0.95:1 to about 1.05.1, from about 0.98:1 to about 1.02:1, or at about 1:1.

As described previously, the PDI-based polyisocyanate and the multi-functional epoxide can be combined and allowed to react in the presence of a reaction catalyst to form a polyoxazolidinone network or composition. Typically, the reaction catalyst can be included in the polyoxazolidinone reaction mixture or composition in an amount of from about 0.25 wt % to about 2 wt % based on a total weight of the composition. In some additional examples, the reaction catalyst can be included in the polyoxazolidinone reaction mixture or composition in an amount of from about 0.5 wt % to about 1.5 wt % based on a total weight of the composition. In some specific examples, the reaction catalyst can be included in the polyoxazolidinone reaction mixture or composition in an amount of from about 0.25 wt % to about 1 wt %, from about 0.75 wt % to about 1.75 wt %, or from about 1.25 wt % to about 2 wt % based on a total amount of the composition.

A variety of reaction catalysts can be employed to produce the polyoxazolidinone compositions described herein. Non-limiting examples can include tetraphenyl phosphonium bromide, a quaternary ammonium halide, a lithium halide, a lithium halide-phosphonium oxide complex, n-butoxy lithium, a tertiary amine, a dialkyl zinc, an organozinc chelate, a trialkyl aluminum, dibutyltin dilaurate, the like, or a combination thereof. Additional reaction catalysts are also described in U.S. Pat. No. 9,458,281, which is incorporated herein by reference. In some specific examples, the reaction catalyst comprises tetraphenyl phosphonium bromide.

In some examples, the polyoxazolidinone compositions can also include one or more additives. Where this is the case, the one or more additives can generally be included in the polyoxazolidinone compositions in an amount of from about 0.01 wt % to about 1 wt % based on a total weight of the composition. In some additional examples, the one or more additives can be included in the polyoxazolidinone compositions in an amount of from about 0.05 wt % to about 0.5 wt %, or from about 0.1 wt % to about 1 wt %.

A variety of additives can be included in the polyoxazolidinone compositions. Non-limiting examples can include a flow aid, a surfactant, a thickener, a solvent, a leveling agent, a wetting agent, a blowing agent, a defoamer, the like, or a combination thereof.

The polyoxazolidinone compositions described herein can generally be thermoset compositions. Additionally, the polyoxazolidinone compositions can be employed as a coating, an adhesive, a sealant, a film, an elastomer, a casting, a foam, a composite, or the like. Further, the polyoxazolidinone compositions can be applied to a surface of a variety of substrates. Non-limiting examples of substrates to which the polyoxazolidinone compositions can be applied can include metal, plastic, wood, cement, concrete, glass, the like, or a combination thereof.

The present disclosure also describes methods of making polyoxazolidinone compositions. Generally, the methods can include catalyzing a reaction of a polyoxazolidinone reaction mixture to form a polyoxazolidinone composition. The reaction mixture can include PDI-based polyisocyanate, poly-functional epoxide, and a reaction catalyst, and optionally a solvent mixture to reduce the viscosity and/or dissolve the catalyst, wherein the PDI-based polyisocyanate and the polyfunctional epoxide are included in the reaction mixture at an equivalent ratio of isocyanate equivalents to epoxide equivalents of from about 0.5:1 to about 1.5:1.

In some additional examples, the method can include preparing the polyoxazolidinone reaction mixture. The polyoxazolidinone reaction mixture can be prepared in a variety of ways. For example, in some cases, the reaction catalyst can be mixed with the PDI-based polyisocyanate to form a PDI mixture. The PDI mixture can then be mixed with the poly-functional epoxide to form the polyoxazolidinone reaction mixture, which can be allowed to react to form the polyoxazolidinone composition. In other examples, the poly-functional epoxide can be mixed with the reaction catalyst to form an epoxide mixture. The epoxide mixture can be mixed with the PDI-based polyisocyanate to form the polyoxazolidinone reaction mixture, which can be allowed to react to form the polyoxazolidinone composition. In yet additional examples, a portion of the reaction catalyst can be mixed with the PDI-based polyisocyanate to form a PDI mixture and another portion of the reaction catalyst can be mixed with the poly-functional epoxide to form an epoxide mixture. The PDI mixture and the epoxide mixture can then be mixed to form the polyoxazolidinone reaction mixture, which can be allowed to react to form the polyoxazolidinone composition. In still additional examples, the PDI-based polyisocyanate and the poly-functional epoxide can be mixed together to form a polyoxazolidinone precursor composition. The reaction catalyst can then be combined with the polyoxazolidinone precursor composition to form the polyoxazolidinone reaction mixture, which can be allowed to react to form the polyoxazolidinone composition. In some additional examples, the reaction catalyst may be pre-dissolved in an appropriate solvent prior to mixing with the PDI-based polyisocyanate, the poly-functional epoxide, or both. In some examples, where the reaction catalyst is dissolved directly in the PDI-based polyisocyanate, the poly-functional epoxide, or both, this can eliminate the need for a solvent.

In some additional examples, catalyzing the reaction between the PDI-based polyisocyanate and the poly-functional epoxide can include curing the polyoxazolidinone reaction mixture to form the polyoxazolidinone composition. Curing can generally include heating the polyoxazolidinone reaction mixture to a temperature of from about 160° C. to about 240° C. for a curing period to prepare the polyoxazolidinone composition. In some additional examples, curing can include heating the polyoxozolidinone reaction mixture to a temperature of from about 180° C. to about 220° C. for a curing period to prepare the polyoxazolidinone composition. In still additional examples, curing can include heating the polyoxazolidinone reaction mixture to a temperature of from about 160° C. to about 200° C., from about 180° C. to about 220° C., or from about 200° C. to about 240° C. for a curing period to prepare the polyoxazolidinone composition.

The curing period can typically be a period of from about 15 minutes to about 2 hours, although other durations of time may be employed in some circumstances. In some examples, the curing period can be a period of from about 15 minutes to about 45 minutes. In some specific examples, the curing period can be from about 15 minutes to about 1 hour, from about 30 minutes to about 1.5 hours, or from about 1 hour to about 2 hours.

In some additional examples, the polyoxazolidinone reaction mixture can be applied to a substrate, such as prior to curing the reaction mixture or prior to allowing the reaction mixture to fully react. The polyoxazolidinone reaction mixture can be applied to a variety of substrates, as described above. Further, the polyoxazolidinone reaction mixture can be applied to a substrate in a variety of ways, such as by injecting, casting, dipping, spreading, dispensing, squeegeeing, spraying, the like or a combination thereof. The polyoxazolidinone reaction mixture can be or can be included in a coating, an adhesive, a sealant, a film, an elastomer, a casting, a foam, a composite, the like, or a combination thereof.

As will be described in further detail below in the Examples section, the polyoxazolidinone compositions described herein can have a variety of surprising thermal and physical properties. For example, in some cases, the polyoxazolidinone composition can have a glass transition temperature of at least 40° C. or at least 45° C. when cured at about 180° C. for about 30 minutes. In some additional examples, the polyoxazolidinone composition can have a glass transition temperature of at least 50° C. or at least 55° C. when cured at about 200° C. for about 30 minutes. In still additional examples, the polyoxazolidinone composition can have a glass transition temperature of at least 90° C., at least 95° C., or at least 100° C. when cured at about 220° C. for about 30 minutes.

Additionally, in some examples, wherein the polyoxazolidinone composition can have an average MEK resistance of at least 250 double rubs or at least 275 double rubs as measured in accordance with ASTM D4752-10(2015) when cured at about 180° C. for about 30 minutes. In still additional examples, the polyoxazolidinone composition can have an average MEK resistance of at least 400 double rubs or at least 425 double rubs as measured in accordance with ASTM D4752-10(2015) when cured at about 200° C. for about 30 minutes. In still additional examples, the polyoxazolidinone composition has an average MEK resistance of at least 950 double rubs or at least 1000 double rubs as measured in accordance with ASTM D4752-10(2015) when cured at about 220° C. for about 30 minutes.

### EXAMPLES

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated. Although the instant Examples are described in the context of a coating, those skilled in the art will appreciate it can also be equally applicable to adhesives, castings, composites, films, elastomers, foams, and sealants.

The following materials were used in preparing the compositions of the Examples:

| | |
|---|---|
| POLYISOCYANATE A | Biobased aliphatic polyisocyanate (PDI-trimer). |
| | As the hardener component for lightfast |
| | polyurethane coating systems, commercially |
| | available from Covestro as Desmodur eco N |
| | 7300; |
| POLYISOCYANATE B | Aliphatic polyisocyanate (high functional |
| | HDI trimer). As the hardener component |
| | for lightfast, rapid-drying polyurethane |
| | coating systems, commercially available |
| | from Covestro as Desmodur N 3790; |
| POLYISOCYANATE C | Aliphatic polyisocyanate (HDI trimer). As |
| | the hardener component for lightfast |
| | polyurethane coating systems, commercially |
| | available from Covestro as Desmodur N |
| | 3300; |
| EPOXY A | Liquid Epoxy Resin is a liquid reaction |
| | product of epichlorohydrin and bisphenol |
| | A, commercially available from OLIN as |
| | D.E.R. 331; |
| ADDITIVE A | a surface additive on polyacrylate-basis |
| | for solvent-borne coating systems and |
| | printing inks, commercially available |
| | from BYK Chemie as BYK 358N; |
| CATALYST A | tetraphenyl phosphonium bromide |
| | catalyst commercially available from |
| | Sigma-Aldrich. |

A 10% by weight solution of CATALYST A was made in dimethyl sulfoxide (DMSO) prior to formulating. Formulations A, B, C, D, E, and F in Table I were prepared by following the same procedure. As an example, Formulation A was prepared as follows; in a 200 mL plastic container 46.55 parts EPOXY A, 0.47 parts ADDITIVE A, 48.24 parts POLYISOCYANATE A, and 4.74 parts CATALYST A mixture were added. The resulting mixture was mixed using a FLACKTEK speed mixer at 2,000 rpm for two minutes followed by application using a draw-down bar.

For glass transition temperature testing, 4″×12″ glass test panels were used. Thickness of films was 2 mils (50 μm). The films were cured at 180° C., 200° C., and 220° C. for 30 minutes. 24 hours after curing the films, they were peeled off the substrates and submitted for analytical testing.

Glass transition temperatures were obtained via differential scanning calorimeter (DSC). DSC analysis using a Diamond DSC was done on the samples heating from −25° C. to 200° C., cooling and reheating rate was at 20° C./min.

For MEK double rubs testing, iron phosphate treated ACT B952, 4″×12″ steel test panels were used. Thickness of films was 2 mils (50 μm). The films were cured at 180° C., 200° C., and 220° C. for 30 minutes. MEK double rubs testing was done at least 24 hours after curing the films.

MEK double rubs were measured according to ASTM D4752-10(2015). Results reported are an average of three readings for each formulation.

TABLE I

| | A | B | C | D | E | F |
|---|---|---|---|---|---|---|
| EPOXY A | 46.55 | 42.09 | 46.61 | 44.44 | 40.19 | 44.50 |
| ADDITIVE A | 0.47 | 0.47 | 0.47 | 0.45 | 0.45 | 0.45 |
| POLYISO- | 48.24 | | | 46.05 | | |
| CYANATE A | | | | | | |
| POLYISO- | | 52.69 | | | 50.31 | |
| CYANATE B | | | | | | |
| POLYISO- | | | 48.18 | | | 46.00 |
| CYANATE C | | | | | | |
| CATALYST A | 4.74 | 4.74 | 4.74 | 9.05 | 9.05 | 9.05 |
| (10% in | | | | | | |
| DMSO) | | | | | | |

Glass Transition Temperature (° C.)

| | | | | | | |
|---|---|---|---|---|---|---|
| Cured at | 48 | 43 | 36 | 56 | 51 | 44 |
| 180° C. | | | | | | |
| Cured at | 58 | 55 | 49 | 69 | 65 | 53 |
| 200° C. | | | | | | |
| Cured at | 103 | 88 | 91 | 97 | 87 | 86 |
| 220° C. | | | | | | |

MEK Double Rubs

| | | | | | | |
|---|---|---|---|---|---|---|
| Cured at | 283 | 176 | 206 | 673 | 433 | 530 |
| 180° C. | | | | | | |
| Cured at | 427 | 473 | 384 | 983 | 933 | 925 |
| 200° C. | | | | | | |
| Cured at | 1000 | 1000 | 1000 | 1000 | 1000 | 1000 |
| 220° C. | | | | | | |

As can be appreciated by reference to Table I, in Examples A, B, C, D, E, and F the type of POLYISOCYANATE and the amount of CATALYST A were varied. Examples A, B, and C received 0.5% by weight CATALYST A. Whereas, Examples D, E, and F received 1.0% by weight CATALYST A. Examples A, and D were formulated using POLYISOCYANATE A. Examples B, and E were formulated using POLYISOCYANATE B. Examples C, and F were formulated using POLYISOCYANATE C.

By looking at glass transition temperature results, it is apparent to those skilled in the art that formulations with POLYISOCYANATE A have higher glass transition temperatures than formulations with either POLYISOCYANATE B, or POLYISOCYANATE C. Similarly, by looking at MEK double rubs results, it is apparent to those skilled in the art that formulations with POLYISOCYANATE A have higher MEK double rubs (better chemical resistance) than formulations with either POLYISOCYANATE B, or POLYISOCYANATE C.

It should be understood that the above-described methods are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. A polyoxazolidinone composition, comprising:
a reaction product of a PDI-based polyisocyanate and a poly-functional epoxide, wherein the PDI-based polyisocyanate and the poly-functional epoxide are combined at an equivalent ratio of isocyanate equivalents to epoxide equivalents of from about 0.5:1 to about 1.5:1 in the presence of a reaction catalyst.

2. The polyoxazolidinone composition of claim 1, wherein the PDI-based polyisocyanate comprises a biuret-containing polyisocyanate, an isocyanurate-containing polyisocyanate, a uretdione-containing polyisocyanate, an allophanate-containing polyisocyanate, or a combination thereof.

3. The polyoxazolidinone composition of claim 1, wherein the poly-functional epoxide has an epoxide equivalent weight of from about 80 g/eq to about 500 g/eq as measured in accordance with ASTM D1652-11(2019).

4. The polyoxazolidinone composition of claim 1, wherein the poly-functional epoxide has a viscosity of from about 50 mPa·s to about 20000 mPa·s at 25° C. as measured in accordance with ASTM D445-19a.

5. The polyoxazolidinone composition of claim 1, wherein the reaction catalyst is present in the composition in an amount of from about 0.25 wt % to about 2 wt % based on a total weight of the composition.

6. The polyoxazolidinone composition of claim 1, wherein the reaction catalyst comprises tetraphenyl phosphonium bromide, a quaternary ammonium halide, a lithium halide, a lithium halide-phosphonium oxide complex, n-butoxy lithium, a tertiary amine, a dialkyl zinc, an organozinc chelate, a trialkyl aluminum, dibutyltin dilaurate, or a combination thereof.

7. The polyoxazolidinone composition of claim 1, wherein the reaction catalyst comprises tetraphenyl phosphonium bromide.

8. The polyoxazolidinone composition of claim 1, further comprising an additive in an amount of from about 0.01 wt % to about 1 wt % based on a total weight of the polyoxazolidinone composition.

9. The polyoxazolidinone composition of claim 8, wherein the additive comprises a flow aid, a surfactant, a thickener, a solvent, a leveling agent, a wetting agent, a blowing agent, a defoamer, or a combination thereof.

10. A substrate, comprising the polyoxazolidinone composition of claim 1 applied to a surface thereof.

11. The substrate of claim 10, wherein the substrate comprises metal, plastic, wood, cement, concrete, glass, or a combination thereof.

12. A method of making a polyoxazolidinone composition, comprising:
catalyzing a reaction of a polyoxazolidinone reaction mixture to form a polyoxazolidinone composition, wherein the polyozazolidinone reaction mixture comprises PDI-based polyisocyanate, poly-functional epoxide, and a reaction catalyst, wherein the PDI-based polyisocyanate and poly-functional epoxide are included in the reaction mixture at an equivalent ratio of isocyanate equivalents to epoxide equivalents of from about 0.5:1 to about 1.5:1.

13. The method of claim 12, wherein catalyzing further comprises curing the polyoxazolidinone reaction mixture at a temperature of from about 160° C. to about 240° C.

14. The method of claim 13, wherein curing is performed for a curing period of from about 15 minutes to about 2 hours.

15. The method of claim 12, wherein the polyoxazolidinone composition forms at least one of a coating, an adhesive, a sealant, a film, an elastomer, a casting, a foam, and a composite.

16. The method of claim 13, wherein the polyoxazolidinone composition has a glass transition temperature of at least 45° C. when cured at 180° C. for 30 minutes.

17. The method of claim 13, wherein the polyoxazolidinone composition has a glass transition temperature of at least 100° C. when cured at 220° C. for 30 minutes

18. The method of claim 13, wherein the polyoxazolidinone composition has an average MEK resistance of at least 250 double rubs as measured in accordance with ASTM D4752-10 (2015) when cured at 180° C. for 30 minutes.

19. The method of claim 13, wherein the polyoxazolidinone composition has an average MEK resistance of at least 950 double rubs as measured in accordance with ASTM D4752-10(2015) when cured at 220° C. for 30 minutes.

20. The method of claim 12, further comprising applying the polyoxazolidinone reaction mixture to a substrate, wherein applying comprises injecting, casting, dipping, spreading, dispensing, squeegeeing, spraying, or a combination thereof.
